(19) United States
(12) Patent Application Publication
(10) Pub. No.: US 2023/0001817 A1
(43) Pub. Date: Jan. 5, 2023

(54) HIERARCHICAL ENERGY MANAGEMENT SOLUTION

(71) Applicant: ELECTRICITE DE FRANCE, Paris (FR)

(72) Inventors: Naji NASSAR, ORSAY (FR); Vojislav STOJANOVIC, PARIS (FR); Ismet ZENUNI, PALAISEAU (FR); Hugo MORAIS, PALAISEAU (FR); William AFONSO, SAINT-MAUR-DES-FOSSES (FR)

(73) Assignee: ELECTRICITE DE FRANCE, Paris (FR)

(21) Appl. No.: 17/779,902

(22) PCT Filed: Nov. 24, 2020
(86) PCT No.: PCT/EP2020/083248

§ 371 Date: May 25, 2022

(30) Foreign Application Priority Data
Nov. 26, 2019 (FR) 1913274

(51) Int. Cl. B60L 53/64; G06Q 50/06; G06Q 10/02; H02J 7/00

(52) U.S. Cl. CPC B60L 53/64; G06Q 50/06; G06Q 10/02; H02J 7/0068

(57) ABSTRACT

A management method for an electric vehicle charging station system. The charging station system includes: several charging stations, each equipped with several charging terminals and one local manager able to pilot the charging terminals; and a main manager able to drive the charging stations. The method includes: the local manager of each charging station getting information associated with vehicles connected to the charging terminals and determining an optimization proposal for electric energy transfer at the level of the charging station; the main manager allocating electric power each charging station on the basis of the optimization proposals; and the local manager of each charging station driving charging terminals based on the allocated power.

### FIELD OF THE INVENTION

The present disclosure arises from the technical field of electric energy transfers.

More specifically, the invention covers management methods for charging station systems for electric vehicles, processing circuits, computer programs, and media for storing data for practicing such methods, such charging station systems and some parts thereof such as main managers, charging stations, and local managers for such charging stations.

### DESCRIPTION OF RELATED ART

The growth over the coming years in the number of electric battery vehicles is going to generate an increased need for charging points in public parking areas.

Current electric vehicle owners have, for the most part, a private parking spot where their electric vehicle can be recharged, such that having an electric vehicle today rests on the necessity of having a consistent, easy and reliable access to a recharging infrastructure. However, today, only a minority of current vehicle owners have a private parking area equipped with a charging terminal. For future electric vehicle owners, this finding is seen as a likelihood that a private charging terminal will not be available.

For this reason, many electric vehicle owners will be compelled to charge their cars at public or shared parking spaces (for example in the street, in a parking area associated with their place of work, on a highway, in a parking area in the business area, etc.).

To face up to these changes, it can be expected that pre-existing infrastructure on public or shared parking areas will be adapted so as to host a larger number of charging terminals or charging stations.

A consequence of this growth is an increased demand on the grid, which involves upgrading the electrical equipment at the parking area, or even the upstream distribution grid.

Connecting all the terminals of the public or shared parking area directly to the electric grid is known, such that the power needed to charge the vehicles is drawn from the distribution grid, which is the only energy source.

Charging of electric vehicles can simply be done instantaneously, meaning that the vehicle starts to be charged upon plugging into a terminal, which behaves like a simple electric outlet.

In the case where the charging infrastructure, formed of the set of terminals for the public or shared parking area, is connected to the distribution grid (medium voltage) via a dedicated transformer; the subscribed power of such infrastructure is conditional on the nominal power of the dedicated transformer. This nominal power amounts, according to the C14-100 standard, to a stacking factor times the sums of the powers of the downstream loads. These downstream loads encompass the loads from the charging infrastructure and possible electric consumption by other equipment, if this other electrical equipment is connected to the distribution grid via the transformer.

The necessary connection power is directly proportional to the number of vehicles that can be recharged simultaneously. Economically this results in an increase of investments which is one of the greatest barriers to the development of terminals and also to the growth of the fleet of electric vehicles. This is the main disadvantage of instantaneous charging.

With the infrastructure described above, it is additionally possible to deploy smart charging algorithms. These algorithms benefit from the fact that cars remain parked and connected for a long time. Instead of charging a car as fast as possible, at the nominal power of the terminal, the goal is to more intelligently distribute the necessary energy over the parking time of the car, by charging at opportune moments. With such a solution, the total power drawn at any moment will be less than or equal to the maximum allowable power for the parking area, where this maximum allowable power may be contractual or technical. In that way, the sizing power for the transformer and also the subscribed power could be reduced.

However, in the case where the power requested reaches the nominal power of the transformer for a fairly long time, it becomes impossible to redistribute the load. In this situation, the algorithm no longer serves to address the need without additional energy supply.

Because it is impossible to draw additional energy from the distribution grid, each additional request will remain unmet.

There is therefore a real need to optimize the energy management of parking areas to allow recharging electric vehicles and, in particular, to minimize the power demand on the grid, so as to avoid as much as possible physically upgrading existing electric facilities.

### BRIEF SUMMARY OF THE INVENTION

The present disclosure aims to improve the situation.

A management method for an electric vehicle charging station system is proposed, where the charging station system comprises:

a plurality of charging stations, where each charging station comprises several electric vehicle charging terminals and a local manager able to drive said charging terminals, where a plurality of said charging terminals are connected to electric vehicles; and

a main manager comprising an energy management module able to drive the charging stations;

where the method comprises:

getting, by the local manager of each charging station and for each electric vehicle connected to a charging terminal of said charging station, information associated with said electric vehicle,

determining, by the local manager of each charging station, an optimization proposal for electric energy transfer over time between said charging station and each electric vehicle connected to a charging terminal of said charging station on the basis of said information obtained;

allocating, by the energy management module of the main manager, electric power for each charging station based on the optimization proposals for electric energy transfer; and

driving, by the local manager of each charging station, the charging terminals of said charging station on the basis of the proposal for optimization of the electric energy transfer over time between said charging station and each electric vehicle connected to a charging terminal of said charging station and an indication of the electric power allocated to said charging station.

“Electric vehicles” designates all vehicles with an electric motor and which can be connected to the electric grid. These comprise electric vehicles with batteries, rechargeable hybrid electric vehicles and electric vehicles with extended operation between recharging. In the context of the invention, electric vehicles does not comprise hybrid vehicles called “non-plug-in” and hydrogen vehicles.

The driving of charging terminals is done at two command levels.

A first command level is located at the local manager of each charging station.

A second command level is located at the main manager able to drive the charging stations.

With these command levels, the driving of the charging terminals is done so as to optimize the electric energy transfers both within each electric station and between each electric station and the electric grid.

Having two command levels reduces the complexity of the method, and increases the modularity, independence and redundancy thereof. Further, this system assures a better monitoring of the state of the electric vehicles in order to optimize the energy transactions and increase the overall effectiveness of the system.

Further, unlike a system with a single command level, the energy is exchanged solely between each charging station and the vehicles connected to this charging station, which limits power losses associated with long-distance electricity transport.

The operation of the first command level is summarized below according to various embodiments.

The local manager gets, for each vehicle connected to a charging station terminal, at least one item of information associated with said vehicle. This information may thus be obtained at any time, meaning before connection of a vehicle to the terminal, during connection of a vehicle to the terminal, or in isolation, repeatedly, periodically or continuously so long as a vehicle is connected to the terminal.

The information obtained from each vehicle is indicative of:

an electric energy need for charging a battery of the vehicle, and/or

availability of electric energy stored in the battery of the vehicle.

The information obtained from each vehicle may comprise, for example:

a measurement of a battery level for said vehicle; and/or

a forecast of the time said vehicle will remain present; and/or

an indication, for example binary, of a charging request for a battery in said vehicle and/or an availability for discharging from a battery in said vehicle.

In that way, the information obtained for each vehicle allows the local manager to both determine:

whether it is necessary to charge the battery of said vehicle; and

whether it is possible to discharge the battery of said vehicle in order, for example, to charge a battery in another vehicle, so as to minimize the power demands from the charging station to the electric grid.

On the basis of this information obtained, the local manager determines an optimization proposal for the energy transfer via the terminals of the charging station, from or to the electric vehicles connected to said terminals as a function of time.

In an embodiment, at least one optimization proposal is determined, by the local manager of a charging station, on the basis of at least one predefined criterion.

In an embodiment, said charging station is connected to an electric grid and said at least one predefined criterion comprises a minimization by said charging station of power demand on the electric grid over time.

In other words, the local manager may propose driving the charging terminals as a function of time so as to minimize power demand on the electric grid from the charging station.

“Minimizing power demand” is understood, in the context of the invention, as corresponding to minimizing:

a number of power demands over time; and/or

electric power demand during a given power demand; and/or

total electric power demand over time.

In that way, it may for example be provided that electric vehicles connected to the charging terminal of the charging station and whose battery has available electric energy are used as an energy source so as to level the power demand on the electric grid from the charging station as a function of time.

According to an implementation, a predefined criterion is a priority level of each vehicle.

“Priority level of each vehicle” is understood to mean a ranking of vehicles such that during the determination of said at least one optimization proposal, the optimization of the energy transfer from or to the better-ranked vehicles, having the highest priority level, has a greater weight than the optimization of the energy transfer from or to less well-ranked vehicles, having a lower priority level.

Of course, said at least one optimization proposal may be determined by the local manager of a charging station on the basis of predefined weighting criteria.

In an embodiment,

a first vehicle is connected to a first charging terminal of a charging station;

a second vehicle is simultaneously connected to a second charging terminal of said charging station;

a first item of information, obtained by the local manager of said charging station, indicates a charging request for a battery in the first vehicle;

a second item of information, obtained by the local manager of said charging station, indicates an availability for discharging a battery in the second vehicle; and

the optimization proposal, for electric energy transfer over time between said charging station and each electric vehicle connected to a charging terminal of said charging station comprises;

charging of said battery in the first vehicle, and simultaneously,

discharging said battery in the second vehicle.

In that way, using the battery in the second vehicle as an alternate electric energy source for supplying the battery in the first vehicle is planned. In this way, the need for the charging station to request an additional energy contribution from the electric grid is considerably reduced.

Having two command levels allows, with an equal number of vehicles connected to the charging terminals, reducing the number of charging terminals connected to the electric grid in so far as each charging station may provide charging and discharging services for several vehicles at the same time.

In an embodiment,

the method further comprises an estimate, by the local manager of a charging station, of the total power requested by the electric vehicles connected to the charging terminals of said charging station over time based on said information obtained by said local manager; and

the optimization proposal is further determined on the basis of said estimate of total power requested.

In that way, the optimization proposal globally considers the power requested by each connected electric vehicle over time. In this way, the optimization proposal considers variations in power requested over time, for example because of the connection of a new vehicle, full charging of the battery of a connected vehicle, or departure of a connected vehicle.

In an embodiment,

the method further comprises an estimate, by the local manager of a charging station, of the total power available by discharging batteries of electric vehicles connected to the charging terminals of said charging station over time based on said information obtained by said local manager; and

the optimization proposal is further determined on the basis of said estimate of a total available power.

In that way, the optimization proposal globally considers the power made available by the electric vehicle batteries connected over time. In this way, the optimization proposal considers available power variations over time.

In an embodiment, the main manager further comprises a reservation management module connected to an access control interface able to drive the local managers, and the method further comprises:

getting, by the reservation management module, a reservation request for a parking place for a vehicle, and

assigning, by the access control interface, a parking place to said vehicle based on the reservation request, where said parking place is equipped with a charging terminal for a charging station of a charging station system.

In that way, prior to the connection of a new vehicle, a future parking place is assigned to the vehicle where this location is chosen so as to optimize the energy transfers both within the charging stations in the system and between each charging station and the electric grid.

The optimization of the placement of the electric vehicles considering the profile thereof and the energy needs thereof serves to optimize the operation of the charging station system.

In an embodiment, the method further comprises:

for the charging station comprising the charging terminal equipping the assigned location, updating an optimization proposal, by the local manager of said charging station, for electric energy transfer over time between said charging station and each electric vehicle connected to a charging terminal of said charging station on the basis of the assignment of the parking place; and

updating the allocation of electric power to each charging station by the energy management module of the main manager on the basis of the update of the optimization proposal for electric energy transfer between said selected charging station and each electric vehicle connected to a charging terminal of said charging station. In that way, prior to the connection of a new vehicle, the driving of the charging terminals of the charging stations is adapted in anticipation of the future connection of the vehicle so as to optimize the energy transfers both within the charging stations in the system and between each charging station and the electric grid.

Another aspect of the invention is a charging station system comprising:

a plurality of charging stations, where each charging station comprises several electric vehicle charging terminals and a local manager able to drive said charging terminals, where a plurality of said charging terminals are connected to electric vehicles; and

a main manager comprising an energy management module able to drive the charging stations;

for each charging station, where the local manager is configured for:

getting for each electric vehicle connected to a charging terminal of said charging station, information associated with said electric vehicle;

determining an optimization proposal for electric energy transfer over time between said charging station and each electric vehicle connected to a charging terminal of said charging station on the basis of said information obtained;

transmitting said optimization proposal to the energy management module of the main manager;

getting from the energy management module of the main manager an indication of electric power allocated to said charging station based on said optimization proposal for electric energy transfer; and

driving the charging terminals of said charging station on the basis of said electric energy transfer optimization proposal and said indication of the allocated electric power;

where the energy management module of the main manager is configured for:

getting for each charging station said optimization proposal for said charging station from the local manager;

allocating electric power each charging station on the basis of said optimization proposals; and

transmitting to the local manager of said charging station an indication for each charging station of the electric power allocated to said charging station.

In the context of the invention, the terms “communicate,” “communication interface,” “drive,” “transmit,” “get” and “connected” in particular refer to data exchanges, for example for instructions, between two entities by means of wired (in particular optical fiber) or wireless (for example Wi-Fi) communication technologies, which may or may not involve the use of a local communication network, a wide area communication network or a communication tunnel.

Another aspect of the invention is a main manager for such an electric vehicle charging station system.

Another aspect of the invention is a charging station for such an electric vehicle charging station system.

Another aspect of the invention is a local manager for such a charging station.

Another aspect of the invention is a processing circuit comprising a processor connected to memory and at least one communication interface with a manager, where the processing circuit is configured for implementing at least one step of a management method such as described above.

In an embodiment, the processing circuit is integrated in a main manager, the at least one communication interface is configured for communicating with the local managers, and the processing circuit is configured for:

getting for each charging station said optimization proposal for said charging station from the local manager;

allocating electric power each charging station on the basis of said optimization proposals; and

transmitting to the local manager of said charging station an indication for each charging station of the electric power allocated to said charging station.

In an implementation, the processing circuit is integrated in a local manager for a charging station; at least one communication interface is configured for communicating with the main manager; at least one communication interface is configured for communicating with the charging terminals of the charging station; and the processing circuit is configured for:

getting for each electric vehicle connected to a charging terminal of said charging station, information associated with said electric vehicle;

determining an optimization proposal for electric energy transfer over time between said charging station and each electric vehicle connected to a charging terminal of said charging station on the basis of said information obtained;

transmitting said optimization proposal to the energy management module of the main manager;

getting from the energy management module of the main manager, an indication of electric power allocated to said charging station based on said optimization proposal for electric energy transfer; and

driving the charging terminals of said charging station on the basis of said electric energy transfer optimization proposal and said indication of the allocated electric power.

Another aspect of the invention is a computer program comprising instructions for implementing the management method such as described above, when said instructions are executed by a processor of a processing circuit.

Another aspect of the invention is a nonvolatile medium for data storage, computer readable, comprising at least one sequence of instructions leading a computer to execute a program executing at least one step of a management method such as described above.

### BRIEF DESCRIPTION OF THE DRAWINGS

Other characteristics, details and advantages will appear upon reading the following detailed description and on analyzing the attached drawings, on which:

FIG. 1 shows a system of charging stations according to an implementation example from the invention.

FIG. 2 shows the type of sequence diagram for a general algorithm for a computer program, in an implementation example for practicing the proposed method.

FIG. 3 schematically shows the structure of a processing circuit of a local manager in an implementation example for practicing the proposed method.

FIG. 4 schematically shows the structure of a processing circuit of a main manager, in an implementation example for practicing the proposed method.

FIG. 5 schematically shows a functional structure of an algorithm implemented by a main manager in an implementation example for practicing the proposed method.

FIG. 6 schematically shows the functional structure of an algorithm implemented by a local manager in an implementation example for practicing the proposed method.

### DETAILED DESCRIPTION OF THE INVENTION

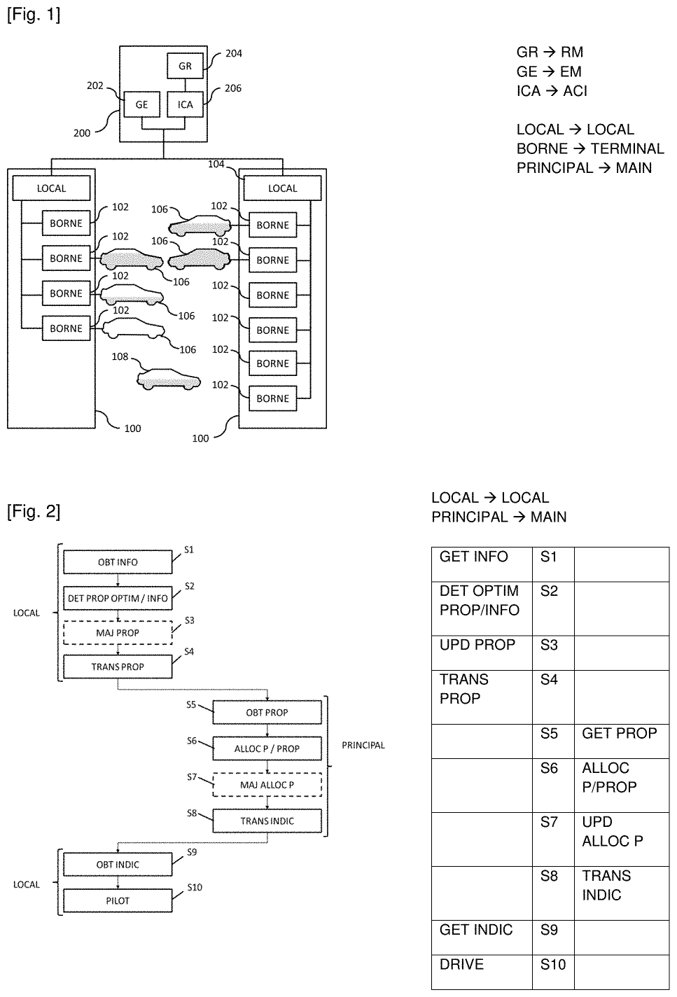

FIG. 1 represents a system of charging stations according to an embodiment example from the invention.

The charging station system comprises a plurality of charging stations (100), each located in the parking area.

Each charging station comprises a plurality of charging terminals (102), each located in a parking place, where each charging terminal is at each moment connected, or not, to an electric vehicle (106).

Each vehicle (106) is equipped with a battery which, when the vehicle is connected to a charging station (102), can be charged or discharged by the charging terminal (102).

Each charging station (100) further comprises a local manager (104) able to drive the charging terminals (102) for charging or discharging the batteries of the vehicles (106) connected to the charging terminals (102).

The charging station system further comprises a main manager (200) connected to the local managers (104). The main manager may for example be installed in a local server for the parking area. The main manager (200) comprises an energy management module EM (202) and may also comprise an energy reservation module (204) and an access control interface ACI (206).

The main manager (200) and the local managers (104) are each equipped with a processing circuit PC.

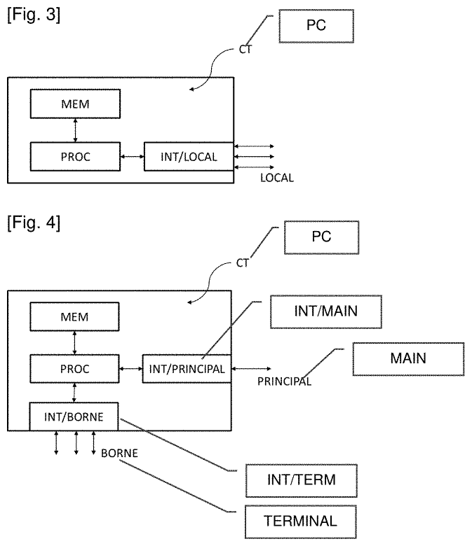

Referring now to FIG. 3 and FIG. 4, showing examples of processing circuits PC respectively for the main manager (200) and the local manager (104).

The processing circuit PC of the main manager (200) comprises local memory MEM, a processor PROC and the communication interface INT/LOCAL with the local managers (104).

The processing circuit PC of a local manager (104) of the charging station (100) comprises memory MEM, a processor PROC, a first interface INT/MAIN for communication with the main manager (200) and a second interface INT/TERM for communication with the charging terminals (102) of the charging station (100).

Now referring to FIG. 2, which shows a type of sequence diagram for a general algorithm for a computer program, in an implementation example for practicing an example of the management method for the charging station system.

In this example, the computer program comprises some instructions intended to be executed at the main manager level (200). For this purpose, these instructions may be stored in the memory MEM of the processing circuit PC of the main manager (200) in order to be executed by the processor PROC of this same processing circuit PC.

In this example, the computer program further comprises other instructions intended to be executed at the level of each charging station (100). For this purpose, for each charging station (100), these instructions may be stored in the memory MEM of the processing circuit PC of the local manager (104) of the charging station (100), in order to be executed by the processor PROC of this same processing circuit PC.

For each charging station (100), the local manager (104) gets GET INFO (51), for each vehicle (106) connected to a charging terminal (102) of the charging station, information associated with the vehicle (106).

The kind of information obtained associated with the vehicle (106) can be quite varied. It is further possible that the kind of information associated with different vehicles could be different.

Without being limited to them, examples of such information include:

a battery-level indication, meaning an indication of whether a battery in the vehicle (106) is discharged, partially charged, or fully charged;

an indication, for example a binary indication, that a battery in the vehicle (106) needs to be charged;

an indication, for example binary indication, that a battery in the vehicle (106) is available as an energy source;

an expected remaining connection time for said vehicle (106) at the charging terminal (102) to which it is connected.

For example, a sensor incorporated in the charging terminal (102) or the vehicle (106) may be provided with which to measure a battery-level indication and make it accessible to the local manager (104).

For example, during connection of the vehicle (106) to a recharging terminal (102), or during a reservation of a recharging terminal (102) for later connection of the vehicle (108) to it, an expected remaining connection time for the vehicle (106, 108) may be automatically predefined.

For example, a network communication interface may be provided between the local manager (104) and a server storing information such as authorization, or not, to use a battery in a given vehicle (106) as an energy source in order to make this information accessible to the local manager (104).

The information obtained for each vehicle may further be associated with a priority level. The priority level may be determined, or not, based on information obtained from said vehicle.

For example, the priority level may be determined on the basis of a measurement of the battery level of the vehicle such that charging a battery whose level is lower is prioritized.

For example, the priority level may be determined on the basis of a forecast of the remaining time said vehicle will be present such that the charging of a battery in a vehicle whose forecast remaining time is sufficiently long compared to the time necessary for charging the battery of the vehicle has a lower priority.

For example, the priority level may be linked to a service subscription, or not, for each vehicle (106), for example a rapid charge service such that the charging of a battery of the vehicle (106) for which such a subscription was made has priority, or for example a service for making energy available such that the battery of the vehicle (106) for which such a subscription was made is used with priority as the source of energy.

In fact, some vehicles (106) may be expected to be able to exchange a portion of the energy stored in the batteries thereof with other vehicles (106). This possibility leads to the introduction of vehicles called “sellers” and vehicles called “purchasers.” The “seller” vehicles are those for which an authorization for discharging the batteries thereof is given, possibly within some predefined limits according to a preestablished compensation. For example, this compensation may be deducted from the parking costs. Conversely, vehicles called “purchasers” are those which need to be recharged and for which the user is able to pay for this service. It is important to mention that one vehicle may be considered as “seller” or “purchaser” at different times.

A method for reserving or assigning parking spaces may be provided, which may for example be practiced by the reservation management module (204) and by the access control interface (206) of the main manager (200).

The access control interface (206) may communicate with a remote server (not shown) providing a function of controlling access to the parking area.

Alternatively, each local manager (104) of the charging station may include such modules, which in that way allow the user to reserve a parking location corresponding to a specific charging station.

This method may comprise:

getting a service reservation for a vehicle (108) through the reservation management module (204); and

confirming the reservation request by the reservation management module (204);

transmitting the reservation request to the access control interface (206);

proposing assigning a charging terminal (102) of a charging station (100) to the vehicle (108) by the access control interface (206) on the basis of the transmitted reservation request;

validating the assignment proposed by the authority controlling access to the parking area; and

assigning the charging terminal (102) to the vehicle (108), by the access control interface (206) and/or by the local manager (104) of the charging station (100) comprising said charging terminal (102), based on the confirmed assignment proposal.

Several user interface types may be proposed for reserving recharging terminals (102) before arrival of a vehicle (108) near the parking area, for example:

a website;

an application on a smart phone type mobile terminal;

an application for an information and/or entertainment system integrated in the vehicle (108).

If a user of vehicle (108) does not make a reservation request before arriving at the parking area, local user interfaces may be proposed. That may range from a simple push button for selecting the electric vehicle profile type, the displays located in practical locations allow all reservation options.

For each charging station (100), the local manager (104) determines DET OPTIM PROP/INFO (S2), a proposal for optimization of electric energy transfer over time between said charging station (100) and each electric vehicle (106) connected to a charging terminal (102) of said charging station (100) on the basis of information obtained, and as applicable priority levels obtained.

The optimization proposal may be determined according to different predefined criteria.

Another example of predefined criterion is to minimize the total power demand from the electric grid by the charging station (100) and/or variations thereof over time. Another example of predefined criterion is to tend towards a complete charge of the batteries of the vehicles (106) connected to the charging terminals (102) of the charging station (100) that is the fastest possible.

Another example of predefined criterion is to keep total power demand from the electric grid by the charging station (100) below a maximum allowable power which may be contractual or technical.

Another example of predefined criterion is to tend, for each vehicle (106) connected to a charging terminal (102) of the charging station (100) to a complete charge of one battery in said vehicle at the end of an estimated remaining connection time. These different predefined criteria may be considered simultaneously and weighted for example under the form of an optimization of a global cost function.

Generally, it is preferable to optimize the use of the available power for each charging station (100) as a function of the needs of the vehicles (106) connected to the charging terminals (102).

A reservation system may further be provided with which a user could interact in order to reserve in advance a place and a charging terminal (102) for their vehicle (108). The data coming from such a reservation system may be accessible by the main manager and constitute an agreement established during the reservation of the charging terminal (102). In an embodiment, it is preferable to optimize the use of the available power for each charging station (100) as a function of the agreements established during reservations of the charging terminals (102).

For each charging station (100), the local manager (104) may update UPD PROP (S3) the optimization proposal on the basis of new information obtained.

For example, the charging station (100) may be located in a parking area, where each charging terminal (102) is at a spot intended for one vehicle (106).

The local manager (104) of a charging station (100) may be provided an indication that a charging terminal (102) is assigned to a vehicle (108), and also all the other information associated with the vehicle (108), such that the local manager (104) updates the optimization proposal on the basis of this new information obtained prior to the connection of the vehicle (108) to the charging terminal (102) which is assigned to them.

The optimization proposal, which could be updated, is then sent, TRANS PROP (S4), via the communication interface INT/MAIN of the processing circuit PC of the local manager (104) to the communication interface INT/LOCAL of the processing circuit PC of the main manager (200).

This transmission may for example be done periodically.

The energy management module (202) of the main manager (200) thus gets GET PROP (S5) an optimization proposal for each charging station (100).

On the basis of the optimization proposals obtained, the energy management module (202) of the main manager (200) allocates ALLOC P/PROP (S6) an electric power to each charging station (100).

The energy management module (202) of the main manager (200) may be configured so as to allocate electric power not only to each charging station (100), but to any other electric resource which may be connected to the main manager (200) (for example an energy storage system, photovoltaic panels, etc.).

In fact, in order to further limit demand on the electric grid one solution is to install a system of storage batteries potentially with other energy resources such as photovoltaic panels. The batteries may be charged preferably during times when the power demand is less than the subscribed power and discharged when the power requested is large.

An associated advantage is the reduction of the total installed capacity of parking inventory because of the possibility of exchanging energy both strictly between vehicles (106) and between one vehicle (106) and other electrical equipment (not shown) connected to the parking inventory (not shown).

Another associated advantage is a maximization of the charging capacity because of the existence of multiple local energy sources (other vehicles (106) and potentially other storage systems).

In order to optimize the management of the system of charging stations, coordination between the energy management module (202) of the main manager (200) and other electric devices may be considered. Because of this coordination, it is possible to increase service reliability, decrease energy requested from the electricity supplier, reduce contracted power and also a reduce upgrade costs. Further, that may reduce the marginal cost of recharging vehicles (106), since the energy can be supplied by resources using primary natural resources (for example, photovoltaic panels) or storage (batteries). All electrical devices that can be controlled, such as production equipment, loads, HVAC systems (heating, ventilation and air conditioning), battery storage systems, etc. are considered as electrical resources.

Further, a machine learning algorithm may be incorporated in the energy management module (202) of the main manager (200) in order to better predict the needs of the vehicles (106). Finally, it can be provided that the main manager (200) communicates via the access control interface (206) with the parking area access control authority in order to offer an optimal spot for each vehicle (108).

In an implementation example, a vehicle user may request a reservation via one of the proposed user interfaces. Once the request is sent to the reservation management module (204) of the main manager (200), it may determine, based on the power allocated to each charging station over time, whether the charging station system is ready, or not, to supply the service requested by the user of the vehicle.

If the charging station system is not ready to supply the requested service, it is expected that the reservation request may for example be rejected and, possibly, another service proposed. For example, a vehicle user wishes to sell 40% of the energy stored in the battery of their vehicle over five-hours time. If the system does not need this quantity of energy during this time, the access/reservation request may be rejected by the reservation management module (204) of the main manager (200), which may also suggest other parking conditions.

If the charging station system is ready to provide the requested service, the main manager (200) may prepare a proposal for assigning a parking place, which is sent to the access control authority at the parking area.

The energy management module (202) of the main manager (200) may further update UPD ALLOC P (S7) the power allocated to one or more charging stations (100), for example, on the basis of getting an update by a local manager (104) of a charging station of an optimization proposal.

For each charging station (100), an indication of the power allocated to the charging station (100), determined and possibly updated by the energy management module (202) of the main manager (200), is then sent TRANS INDIC (S8), via the communication interface INT/LOCAL of the processing circuit PC of the main manager (200), to the communication interface INT/MAIN of the processing circuit PC of the local manager (104) of the charging station (100).

This transmission may for example be done periodically.

For each charging station (100), the local manager (104) thus gets GET INDIC (S9), an indication of the power allocated to the charging station (100) by the energy management module (202) of the main manager (200).

For each charging station (100), the local manager (104) drives DRIVE (S10) the charging terminals (102) on the basis of both the indication of the power allocated to the charging station (100) and the optimization proposal previously established by the local manager (104).

In a scenario where autonomous vehicles with electric motors emerge, the local manager (104) of the charging station (100) could command the autonomous vehicles will finish their task to change spots, leaving the charging terminals (102) free for other vehicles (106). This could improve the efficiency and profitability of the parking area and the recharging infrastructure.

### Example

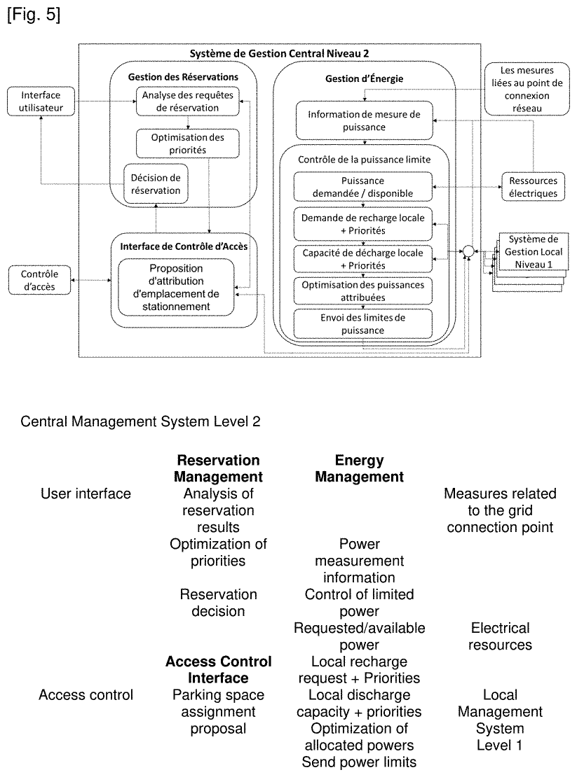

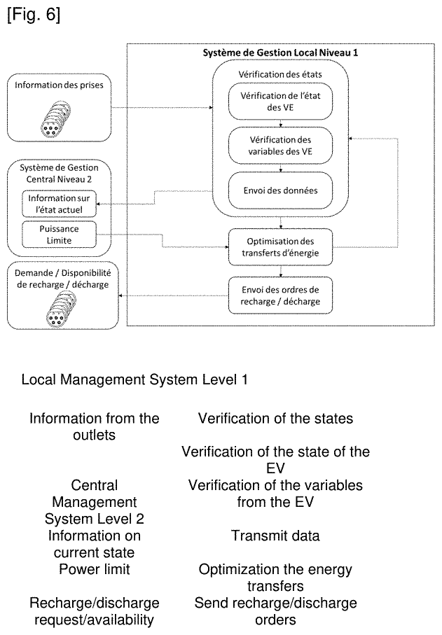

Now referring to FIG. 5 and FIG. 6, which show a specific implementation example, in which the functions respectively practiced by each local manager (104) local management system level 1 (L1) and by the main manager (200) (central management system level 2, L2) are described below.

At level 2 (L2), the global parking area functions are monitored and controlled. The main manager (200) fulfills three functions: managing reservations, access control interface and energy management.

The management of reservations is a function intended to guarantee a proper reservation of the parking places. The users can access one of the reservation platforms through the user interface, enter their recharging requests, the period during which they wish to use the service and whether they want their electric vehicle (EV) to sell or purchase. Next, in the priority optimization zone, the system must analyze, accept or refuse the request, depending on the situation and the usage case implemented, and then inform the user of their costs/compensation under the general conditions of the agreement. Once the reservation is made, the user gets a record of this transaction. The optimization zone places vehicles by priority order depending on the client's subscription, the requested energy and the length of parking.

The access control interface is a function intended to provide the access control authority the optimal spot for the EV in the parking area in real time. When the proposal is accepted/refused by the access control authority, the decision is sent to the reservation decision block. Finally, this block informs the owner of the EV of the status of their request.

Management of the energy is a function dedicated to the manager of the energy transaction between all electrical resources of the parking area. This function aims to comply with the power limit of the connection point to the grid, while also guaranteeing client satisfaction. In order to provide for adequate management, the main manager (200) gathers power measurements from all electrical resources, including the connection point to the grid. Next, the system gathers the power request/capacity of all electrical resources, the local load request and the local discharge capacity at the level of the local managers (104) which are responsible for energy transactions between electric vehicles connected to the same station. Also, the local management at level 1 (L1) indicates the priorities used for optimizing the assigned power in order to guarantee the maximum satisfaction of the clients and optimize the use of the electrical infrastructure for the parking area. Using these input data, the optimization of the power assigned leads to the generation of power limit commands to the local managers (104) which conditions the charging/discharging commands for the charging terminals (106). There are several objectives to the optimization of the energy management at level 2 (L2):

reduce the overall cost of the electricity or of the electricity bill;

maximizing the availability of energy for a faster charging service; and

maximizing the satisfaction of the client by guaranteeing a rapid service.

Level 1 (L1) manages in real time the vehicles (106) (EV) connected to each charging terminal (102). Level 2 (L2) is responsible for the centralized management at the parking area level with a forecast management approach.

At level 1 (L1), the objective of the local manager (104) is to use all the available power in the recharging terminal for addressing the need of the EV the quickest possible. Further, if the EV are vendors, the system must use the power thereof for charging the EV connected to the same terminal in the case of multioutlet terminals or supply energy to the other terminals. In order to guarantee this optimization, a weighting system (ω) is used. The weights of each EV are updated with each time step (5 or 10 minutes) by an auxiliary calculation or at level 2 (L2).

Level 1 (L1) is responsible for the energy transaction between the electric vehicles (“sellers” and “buyers”) and between the buyers and other electric resources. Further, this management level guarantees the satisfaction of all requests made for all connected electric vehicles. The local manager (104) contains a state control model which frequently verifies the state of the battery of the electric vehicles. This module verifies the activation state of the vehicles, the state indicators of the battery (state of health (SoH)—state of charge (SoC)), the charging/discharging capacity and other factors such as the estimated departure time. These factors are next transformed into requests and priorities which are sent to the level 2 (L2) main manager (200). Further, they are used for optimizing the energy transactions as constraints to be satisfied in order to keep an optimal energy transaction without damaging the batteries of the electric vehicles. At this management level, optimization has the following objectives:

reducing the charging time;

maximizing the use of energy from the vendor; and

satisfying as best as possible the assignments before the estimated departure time of the EV.

Level 1 (L1) may also record the charging behaviors of the electric vehicles in order to be able to send them to the main manager (200) in order for them to be used subsequently in the parking place assignment function for an optimized distribution of the energy demand of the electric vehicles distributed over different charging stations.

1.-15. (canceled)

16. A management method for an electric vehicle charging station system, wherein the charging station system comprises:
a plurality of charging stations, where each charging station comprises several electric vehicle charging terminals and a local manager able to drive said charging terminals, where a plurality of said charging terminals are connected to electric vehicles; and
a main manager comprising an energy management module able to drive the charging stations;
wherein the method comprises:
getting, by the local manager of each charging station and for each electric vehicle connected to a charging terminal of said charging station, information associated with said electric vehicle,
determining, by the local manager of each charging station, an optimization proposal for electric energy transfer over time between said charging station and each electric vehicle connected to a charging terminal of said charging station on the basis of said information obtained;
allocating, by the energy management module of the main manager, electric power for each charging station based on the optimization proposals for electric energy transfer; and
driving, by the local manager of each charging station, the charging terminals of said charging station on the basis of the proposal for optimization of the electric energy transfer over time between said charging station and each electric vehicle connected to a charging terminal of said charging station and an indication of the electric power allocated to said charging station.

17. The management method according to claim 16, wherein at least one optimization proposal is determined, by the local manager of a charging station, on the basis of at least one predefined criterion.

18. The management method according claim 17, wherein said charging station is connected to an electric grid and said at least one predefined criterion comprises a minimization by said charging station of power demand on the electric grid over time.

19. The management method according to claim 16, wherein: a first vehicle is connected to a first charging terminal of a charging station;
a second vehicle is simultaneously connected to a second charging terminal of said charging station;
a first item of information, obtained by the local manager of said charging station, indicates a charging request for a battery in the first vehicle;
a second item of information, obtained by the local manager of said charging station indicates an availability for discharging a battery in the second vehicle; and
the optimization proposal, for electric energy transfer over time between said charging station and each electric vehicle connected to a charging terminal of said charging station comprises:
charging of said battery in the first vehicle; and, simultaneously,
discharging said battery in the second vehicle.

20. The management method according to claim 16, further comprising an estimate, by the local manager of a charging station, of the total power requested by the electric vehicles connected to the charging terminals of said charging station over time based on said information obtained by said local manager; and
wherein the optimization proposal is further determined on the basis of said estimate of total power requested.

21. The management method according to claim 16, further comprising an estimate, by the local manager of a charging station, of the total power available by discharging batteries of electric vehicles connected to the charging terminals of said charging station over time based on said information obtained by said local manager; and
wherein the optimization proposal is further determined on the basis of said estimate of a total available power.

22. The management method according to claim 16, wherein the main manager further comprises a reservation management module connected to an access control interface able to drive the local managers, and the method further comprises:
getting, by the reservation management module, a reservation request from a parking place for a vehicle, and
assigning, by the access control interface, a parking place to said vehicle based on the reservation request, where said parking place is equipped with a charging terminal for a charging station of a charging station system.

23. The management method according to claim 22, further comprising:
for the charging station comprising the charging terminal equipping the assigned location, updating an optimization proposal, by the local manager of said charging station, for electric energy transfer over time between said charging station and each electric vehicle connected to a charging terminal of said charging station on the basis of the assignment of the parking place; and
updating the allocation of electric power to each charging station by the energy management module of the main manager on the basis of the update of the optimization proposal for electric energy transfer between said selected charging station and each electric vehicle connected to a charging terminal of said charging station.

24. A charging station system comprising:
a plurality of charging stations, where each charging station comprises several electric vehicle charging terminals and a local manager able to drive said charging terminals, where a plurality of said charging terminals are connected to electric vehicles; and
a main manager comprising an energy management module able to drive the charging stations;
for each charging station, where the local manager is configured for:
getting for each electric vehicle connected to a charging terminal of said charging station, information associated with said electric vehicle;
determining an optimization proposal for electric energy transfer over time between said charging station and each electric vehicle connected to a charging terminal of said charging station on the basis of said information obtained;
transmitting said optimization proposal to the energy management module of the main manager;
getting from the energy management module of the main manager an indication of electric power allocated to said charging station based on said optimization proposal for electric energy transfer; and
driving the charging terminals of said charging station on the basis of said electric energy transfer optimization proposal and said indication of the allocated electric power;
wherein the energy management module of said main manager is configured for:
getting for each charging station said optimization proposal for said charging station from the local manager;
allocating electric power each charging station on the basis of said optimization proposals; and
transmitting to the local manager of said charging station an indication for each charging station of the electric power allocated to said charging station.

25. A main manager for charging station system for electric vehicles according to claim 24.

26. A local manager for charging station system for electric vehicles according to claim 24.

27. The local manager of the charging station according to claim 26.

28. A processing circuit comprising a processor connected to memory and at least one communication interface with a manager, where the processing circuit is configured for implementing at least one step of a management method according to claim 16.

29. A computer program comprising instructions for implementing the management method according to claim 16, when said instructions are executed by a processor of a processing circuit.

30. A nonvolatile medium for data storage, computer readable, comprising at least one sequence of instructions leading a computer to execute a program executing at least one step of a management method according to claim 16.
